(19) United States
(12) Patent Application Publication
(10) Pub. No.: US 2016/0004672 A1
(43) Pub. Date: Jan. 7, 2016

(54) Method, System, and Tool for Providing Self-Identifying Electronic Messages

(71) Applicants: Patty Sakunkoo, Palo Alto, CA (US); Nathan Sakunkoo, Palo Alto, CA (US)

(72) Inventors: Patty Sakunkoo, Palo Alto, CA (US); Nathan Sakunkoo, Palo Alto, CA (US)

(21) Appl. No.: 14/792,890

(22) Filed: Jul. 7, 2015

Related U.S. Application Data
(60) Provisional application No. 62/021,696, filed on Jul. 7, 2014.

(51) Int. Cl. G06F 17/21; H04L 12/58

(52) U.S. Cl. CPC G06F 17/214; H04L 51/046

(57) ABSTRACT

An electronic messaging system including first and second user devices wherein each user device receives a plurality of user-generated glyphs, defines a font using the plurality of user-generated glyphs, receives a message styled in the font, exchanges the font and the message with the other user device, and displays the sent message styled in the sent font and the received message styled in the received font. The user-generated glyphs may be received by the user drawing the glyphs on a touchscreen interface, by taking an image of handwritten glyphs, and by remixing existing fonts.

### CROSS-REFERENCE TO RELATED APPLICATIONS

This application incorporates by reference and claims the benefit of priority to U.S. Provisional Patent Application No. 62/021,696 filed Jul. 7, 2014.

### BACKGROUND OF THE INVENTION

The present subject matter relates generally to electronic messaging on a mobile device. More specifically, the present invention relates to systems and methods of mobile messaging permitting enhanced expressivity using user-generated fonts.

Electronic text messages are commonly used by mobile users to send many types of information, ranging from business correspondences to emotional messages (e.g. one study showed that over 50% of mobile users have sent “I love you” via a text message.) While they provide superior speed to writing, the recipient of a text message cannot identify whose message it is from, based on the visual style of the message alone, unless it is accompanied by an avatar, name, or phone number of the sender, or inferred from the content of the message.

On the contrary, one can usually tell quickly whose note it is from if it's handwritten as handwriting has long been known to associate strongly with each individual. While much slower than typing and more difficult to send, handwriting represents individuality, personality, and emotion of the owner.

To compromise, some users of mobile communication devices have resorted to express and identify themselves beyond the content of the message by writing a desired message on the screen of an electronic device (e.g. “I miss you.”) via a draw pad and a finger or stylus. The system then saves the written note, typically as an image of the fixed subset of characters, and then sends to the recipient who sees the image. While this is more personalized than the standard text messages and helps identify who the sender is, based on the way it's written, there are multiple problems with this method. One is the problem of repetitiveness: if the sender later wants to send the same message or a similar message, he would have to write again. Another problem is that the images are neither sharp nor scalable.

Therefore, in light of the problems of self-identification, reusability, and speed described above, we identify an unrecognized need for a method and system for providing self-identifying electronic messages that help the users to self-identify.

Additionally, in previous message systems, message texts are often too small to comfortably read, especially for the elderly. Currently, a user may only have the option to set the whole text size of the device (such as may be accomplished on Android devices), or on a particular app that allows font size setting. Also, a single font size doesn't allow for expression of emotions such as by shouting or whispering. In previous systems, the conventional way to make a text larger is to press a button and then adjust by clicking + or − or with a slider. There is also a gesture-based pinching with 2 fingers as in photo-pinching. All of these are cumbersome. Thus, there is a need for improved mobile devices providing easy-to-use font size adjustment.

Further, current keyboard tools on mobile devices have limited functionality for choosing font. Generally, existing tools have limited preview of a chosen font. For example, to preview a chosen font, the user either has to select a font, then type in that font, or the user has to type text and then highlight a certain part of the text and then change the font, as is commonly used in the popular Gmail email font-setting menu. Another popular way to preview a font is to use the font name as the preview characters (e.g. as used in Photoshop font selector). Yet, another way is to have a placeholder text such as “Type your message here” shown in the chosen font. All these approaches offer only a limited number of characters for preview, not the whole alphabet set. Thus, there is a need for improved preview of chosen fonts to permit a user to easily choose a desired font.

Accordingly, there is a need for mobile messaging permitting enhanced expressivity and identity using user-generated fonts, as described herein.

### BRIEF SUMMARY OF THE INVENTION

To meet the needs described above and others, the present disclosure provides a self-identifying messaging system including mobile device systems and methods for enhanced mobile messaging permitting enhanced expressivity and identity using user-generated fonts.

In an embodiment, the self-identifying messaging system may permit a first user to communicate with a second user via user devices. The self-identifying messaging system may permit each user to create a personal font of user-generated glyphs, and then compose a message by using the user-generated glyphs as type. Since the first user may create his or her own personalized set of user-generated glyphs, the message composed with these user-generated glyphs is highly individualized and hence self-identifying. The second user benefits by being able to quickly tell whom the first user is by simply glancing and recognizing the visual style of the message and user-generated glyphs particular to the first user. By using user-generated glyphs as type, the self-identifying messaging system provides the convention benefits of typing, such as, spell-checking and auto-completion that enhance the speed of typing, while preserving the individuality of the user's handwriting.

Each user device may be a smartphone, such as an iOS- or Android-enabled smartphone, running a mobile device application of the self-identifying messaging system. The communication between the user devices may be coordinated by a chat server that may, for example, receive and forward messages from the first user to the second user over a network, such as the Internet. The first user and second user may each have a personal font that is generated by each user, exchanged between the first user and the second user, and used to display messages from the corresponding user. A personal font may be embodied as a file including a set of scalable vectors describing the rendering of the user-generated glyphs. The personal font may additionally include a mapping of user-generated glyphs to characters of an outside encoding, such as Unicode.

In an embodiment, the self-identifying messaging system may include a mobile device application that may be installed on the user devices. As noted, the mobile device application may permit the first user to send messages to the second user using the mobile device application, and vice versa. Additionally, in some embodiments, the mobile device application may permit the first user to send messages to mobile devices not running the mobile device application. For example, the mobile device application may permit the first user to send messages to other mobile devices via SMS, email, or other communication protocols. The user devices may be mobile devices such as an iOS®, Android®, Windows® or other commercially available or special purpose mobile device.

In an embodiment, the self-identifying messaging system may include a chat window of the mobile device application. As shown, the first user and the second user may send messages to each other each using their own personal font. Each message may include message text that may be rendered using the user-generated glyphs of each user's personal font and may additionally include media such as images, sound, video, etc.

To provide a personal font for use in chat, the first user may generate the personal font by a variety of font generation mechanisms provided by the mobile device application to permit the first user to use a convenient mechanism. For example, the first user may access an integrated drawing pad screen of the mobile device application to input user-generated glyphs. The first user may choose which characters of a character set to include or exclude for input as user-generated glyphs. For example, the first user may be prompted to choose whether to enter lower case (a-z), upper case (A-Z), punctuations, numbers, foreign characters, emoticons, user drawings, etc., as user-generated glyphs. The integrated drawing pad screen may then prompt the first user with a characters prompt. The first user may draw over the character prompt using the user interface. In an embodiment, the user interface is a touchscreen. The user device may record the user input from the user interface and simultaneously display the resulting glyph overlaid over the character prompt. The user input may be used to create a user-generated glyph for that character prompt. The first user may be permitted to re-draw the glyph until perfected.

Each user-generated glyphs may be associated with the corresponding character to permit the mobile device application to define the personal font and to permit the mobile device application to render a viewable message from a digitally readable character encoding of the message.

The first user may also be permitted to choose line width, line shape, line color, stippling, and other drawing effects to permit a wide variety of expression. For example, the first user may select a brush button to change the line width, line shape, line color, stippling, etc. An erase button may be displayed to permit the user to erase a portion of the user input. An undo button may permit the first user to undo changes, such as undoing additional brush strokes stroke-by-stroke, or undoing changes to the line width, line shape, line color, stippling, etc. The first user may also be permitted to chose a font type for the underlying character prompt to permit the first user to emulate a variety of font styles.

As another example of a font generation mechanisms, the first user may input one or more user-generated glyphs by taking an image of the user-generated glyphs using a font capture screen. The first user may begin by drawing one or more hand-drawn glyphs on a drawing surface, such as paper. The first user may then open the font capture screen for capture. The font capture screen may display a processed live feed from the camera. In an embodiment, the mobile device application may process the live feed by inverting the colors (thus turning black hand-drawn glyphs from black to white) and applying a brightness threshold filter controlled by a brightness threshold slider. When the first user has the hand-drawn glyphs appropriately centered and in-focus in the live feed, the first user may press a shutter button to capture an image of the hand-drawn glyphs.

The mobile device application may then use optical character recognition (OCR) to recognize the character corresponding to each hand-drawn glyph to generate a user-generated glyph. In some embodiments, the mobile device application may present the recognized hand-drawn glyph to the first user, and allow the first user to fine-tune the segmentation by manually selecting which part of the image to record as which character. The font capture screen may include various tools to fine-tune the recognition of user-generated glyph, such as the brightness threshold slider to permit the improved recognition of hand-drawn glyph relative to the background.

For either of the font generation mechanisms, the first user may be permitted to input less than the whole set of characters for a font. Once the first user writes a predetermine number of characters of the character set, the self-identifying messaging system may then auto-fill the rest of the characters of the character set with simulated user-generated glyphs to complete the personal font by leveraging a database of other users' personal fonts and identifying the ones that resemble the first user's style.

For example, the provided user-generated glyphs from the first user may be uploaded by the user device to the chat server. The chat server may scan the database of stored fonts to match the user-generated glyphs from the first user to user-generated glyphs of the stored fonts. In an embodiment, the top matching stored personal font may be used to fill in user-generated glyphs for those characters for which the first user did not provide user-generated glyphs. It is contemplated that the user-generated glyphs does not need to match a stored personal font exactly to form a match, rather the top scoring match may be determined by a similarity score calculated for the user-generated glyphs and the stored personal fonts.

In another embodiment, a plurality of matching stored personal fonts may be combined or interpolated to fill in user-generated glyphs. Alternatively, in other embodiments, machine learning and artificial intelligence methods may be used to generate the remaining user-generated glyphs by using the user-generated glyphs as inputs to a generative model. Thus, the first user may provide user-generated glyphs for characters such as ‘A’ through ‘M’, and may request an auto-generation of characters such as ‘N’ through ‘Z’. Although described as being generated by the chat server, it is contemplated that auto-generation may be accomplished by the user device.

In further embodiments of a font generation mechanisms, the first user may be permitted to “remix” other user's personal fonts using a remix screen. The first user, for example, may choose one or more selected glyphs from one or more stored personal fonts of the database for inclusion in a personal font. As shown, the first user has selected the user-generated glyphs 80 ‘C’, ‘D’, and ‘E’ from Font A, the user-generated glyphs 80 ‘E’, ‘F’, ‘G’, ‘H’, ‘J’, ‘K’, and ‘L’ from Font B, and the user-generated glyph T from Font C. Once chosen, the first user may be presented with the integrated drawing pad screen to tweak the designs of individual user-generated glyphs.

When the first user has finished editing the user-generated glyphs using any of the font generation mechanisms, the user device generates a personal font by converting the user-generated glyphs into a set of scalable vectors and creating a font definition file in the first user's personalized library both locally and on the chat server. The font definition file may be associated with the first user and may be distributed to the second user and other chat partners to permit the correct display of the first user's messages. It is contemplated that the first user may be associated with more than one personal font.

Once the first user has defined a personal font, it may be used when sending messages. To send the message between the user devices of the first user and the second user, the message text of the message is sent together with metadata identifying the selected personal font to the chat server. The chat server may then deliver the message to the user device of the second user. The message may include metadata referencing the personal font to use to render the message. The referenced personal font may be delivered by a variety of methods as will be described. In an embodiment of the self-identifying messaging system, any or all of the described delivery methods may be used.

In the first delivery method, for each message, a subset of the user-generated glyphs of the personal font sufficient to render the message along with the message text is sent from the first user to the second user. For example, the user-generated glyphs [“I”,“L”,“O”,“V”,“E”,“Y”,“U”] may be sent for the message “I LOVE YOU.” This implementation minimizes the payload size and the number of requests when sending the first and subsequent messages.

In a second implementation, all user-generated glyphs for all characters in the personal font are delivered with the first message sent from the first user to the second user. This implementation minimizes the payload size over the long run since no user-generated glyphs need to be sent on subsequence messages.

In a third implementation, only an ID, name, or uniform resource locator of the personal font is sent. For example, the user device of the first user may send a uniform resource locator (URL) pointing to the personal font on a server such as the chat server. The receiving user device may the download and locally store the required personal font for rendering as needed. This implementation minimizes the payload size of the message but requires an extra request to download the personal font from the chat server. For example, in an embodiment, the message is sent via SMS. The SMS metadata or message may include a URL, such as a “shortened” URL (a URL using only a domain and top-level domain constructed to have a short character length) that permits the receiving device to access the personal font.

A messaging screen may be provided to enable a conversation between the first user and the second user. The first user may be permitted to choose a personal font from a personalized library menu. The first user may then type a message in the chosen personal font. A font color menu may also be included in the messaging screen to permit the first user to vary the color of the message. To permit increased expressivity, the first user may be permitted to vary a font size for the message.

To permit font size adjustment, the self-identifying message system may include gesture-based adjustment of font and character sizes. In an embodiment, when the first user is entering message text into a textbox of a messaging screen, the first user may swipe right across the textbox with a single finger right swipe gesture to enlarge the text size and swipe left with a left swipe gesture across the textbox to shrink the text size. To prevent unwanted size changes, the self-identifying message system may distinguish between a single tap to activate the textbox versus a long swipe to change font size. By providing a one-finger swipe directly on the textbox, the self-identifying message system permits greater speed and precision when adjusting text size.

It is contemplated that in other embodiments, multi-finger gestures may be used to adjust text size in place of a single finger swipe. Additionally, it is contemplated that in some embodiments the functionality of the left swipe gesture and the right swipe gesture may be reversed, that is, a left swipe gesture may increase the text size and a right swipe gesture may decrease the text size. Further, it is contemplated that other swipe directions may be utilized, for example, the first user may swipe up across the textbox with a single finger to enlarge the text size and swipe down across the textbox to shrink the text size.

Additionally, the self-identifying messaging system may include a keyboard that displays a chosen personal font on the keys. The first user may change the selected personal font by scrolling through a list of available fonts in the personalized library menu. When a user chooses a personal font in the list, the keyboard may be updated to show a user-generated glyph for each font character of the personal font in the appropriate location. In some embodiments, the first user may change personal fonts for different message characters of a message to permit greater expressivity in the message, such as emphasizing words, showing emotion, changing tone, etc.

In an embodiment, an electronic messaging system includes: a first user device; and a second user device in communication with the first user device; wherein the first user device includes a first wireless communication subsystem, a first user interface, a first controller in communication with and controlling the operation of the first wireless communication subsystem and the first user interface, and a first memory in communication with the first controller, the first memory including instructions that, when executed by the first controller, cause the first controller to prompt, via the first user interface, input of a first plurality of user-generated glyphs into the first user interface, wherein each user-generated glyph is uniquely associated with a character, receive, via the first user interface, the first plurality of user-generated glyphs, define a first font using the first plurality of user-generated glyphs, receive, via the first user interface, a first message styled in the first font, transmit the first font and the first message to the second user device via the first wireless communications module, receive a second font and a second message via the first wireless communications module, and display, via the first user interface, the first message styled in the first font and the second message styled in the second font, wherein the second user device includes a second wireless communication subsystem, a second user interface, a second controller in communication with and controlling the operation of the second wireless communication subsystem and the second user interface, and a second memory in communication with the second controller, the second memory including instructions that, when executed by the second controller, cause the second controller to: prompt, via the second user interface, input of a second plurality of user-generated glyphs into the second user interface, wherein each user-generated glyph is uniquely associated with a character, receive, via the second user interface, the second plurality of user-generated glyphs, define the second font using the second plurality of user-generated glyphs, receive, via the second user interface, the second message styled in the second font, transmit the second font and the second message to the first user device via the second wireless communications module, receive the first font and the first message via the second wireless communications module, and display, via the second user interface, the first message styled in the first font and the second message styled in the second font.

In some embodiments, the first user interface includes a touchscreen interface, wherein the step of prompting input of the first plurality of user-generated glyphs includes displaying a character on the touchscreen interface, wherein the step of receiving, via the first user interface, the first plurality of user-generated glyphs includes receiving a series of points via the touchscreen interface.

In some embodiments, the step of defining the first font using the first plurality of user-generated glyphs includes generating a scalable vector representation of each of the first plurality of user-generated glyphs.

In some embodiments, the first plurality of user-generated glyphs is a set of a series of points received by the first user interface, wherein each user-generated glyph is defined by a series of points of the set. Similarly, in some embodiments, the first plurality of user-generated glyphs includes a first selection of glyphs from a first font and a second selection of glyphs from a second personal font, wherein the step of defining the font from the first user-generated glyphs includes defining the first font to include the first selection of glyphs and the second selection of glyphs.

Additionally, in some embodiments, the first plurality of user-generated glyphs is received via a camera input. For example, in some embodiments, the step of defining the first font from the user-generated glyphs includes performing optical character recognition on a portion of the camera input to segment the camera input into the first plurality of user-generated glyphs.

In some embodiments, the electronic messaging system further include a chat server including a database of stored personal fonts, wherein the chat server is configured to: receive the first plurality of user-generated glyphs, select a font from the stored personal fonts, wherein the selected font includes glyphs matching the first plurality of user-generated glyphs, and select glyphs from the selected font for a plurality of characters not associated with the first plurality of user-generated glyphs to include in the first font.

In some embodiments, the memory includes further instructions that, when executed by the controller, cause the controller to: display a textbox including text of a user-entered message, wherein the text includes a font size, when the first user interface receives a swipe right gesture over the textbox, increase the font size of the text of the user-entered message, and when the first user interface receives a swipe left gesture over the textbox, decrease the font size of the text of the user-entered message.

In some embodiments, the memory includes further instructions that, when executed by the controller, cause the controller to: display a messaging screen including a keyboard, wherein the keyboard includes a plurality of keys, each key including a user-generated glyph.

An object of the invention is to provide personalized messaging that permits users to enhance expressivity in their messages.

An advantage of the invention is that it provides a messaging system that permits users to self-identify with text, and provides originality, uniqueness to an individual, and even creativity.

Another advantage of the invention is that it provides various mechanisms for a user to create characters that express a user's personal identity and style.

A further advantage of the invention is that it provides easy to use gestures to control the size of characters.

Yet another advantage of the invention is that it provides the ease-of-use when previewing fonts for use in messaging.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 illustrates an example of a self-identifying messaging system.

FIG. 2 is a diagram illustrating an example mobile device of the self-identifying messaging system of FIG. 1 that includes a mobile device application for enabling communication between users.

FIG. 3 illustrates a chat window of the mobile device application of the self-identifying messaging system of FIG. 1.

FIG. 4 illustrates an integrated drawing pad screen 400 of the mobile device application of self-identifying messaging system of FIG. 1 to permit a user to input glyphs.

FIG. 5 illustrates a font capture screen of the mobile device application to permit a user to input one or more user-generated glyphs by taking a photograph of handwritten glyphs.

FIG. 6 illustrates a remix screen of the mobile device application to permit a user to create a font from other existing fonts.

FIG. 7 illustrates a messaging screen of the mobile device application upon which a user is performing a right swipe gesture to enlarge the message font.

FIG. 8 illustrates a messaging screen of the mobile device application upon which a user is performing a left swipe gesture to enlarge the message font.

### DETAILED DESCRIPTION OF THE INVENTION

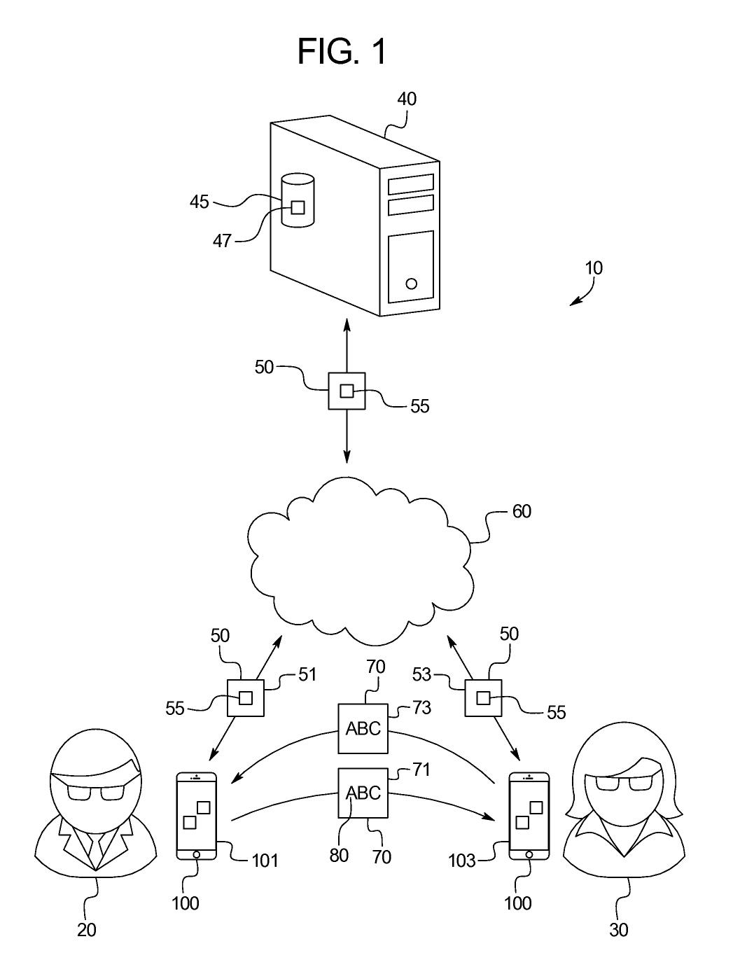

FIG. 1 illustrates an example of a self-identifying messaging system 10. As shown in FIG. 1, the self-identifying messaging system 10 may permit a first user 20 to communicate with a second user 30 via user devices 100. The self-identifying messaging system 10 may permit each user to create a personal font 70 of user-generated glyphs 80, and then compose a message 50 by using the user-generated glyphs 80 as type. Since the first user 20 may create his or her own personalized set of user-generated glyphs 80, the message 50 composed with these user-generated glyphs 80 is highly individualized and hence self-identifying. The second user 30 benefits by being able to quickly tell who the first user 20 is by simply glancing and recognizing the visual style of the message 50 and user-generated glyphs 80 particular to the first user 20. By using user-generated glyphs 80 as type, the self-identifying messaging system 10 provides the convention benefits of typing, such as, spell-checking and auto-completion that enhance the speed of typing, while preserving the individuality of the user's handwriting.

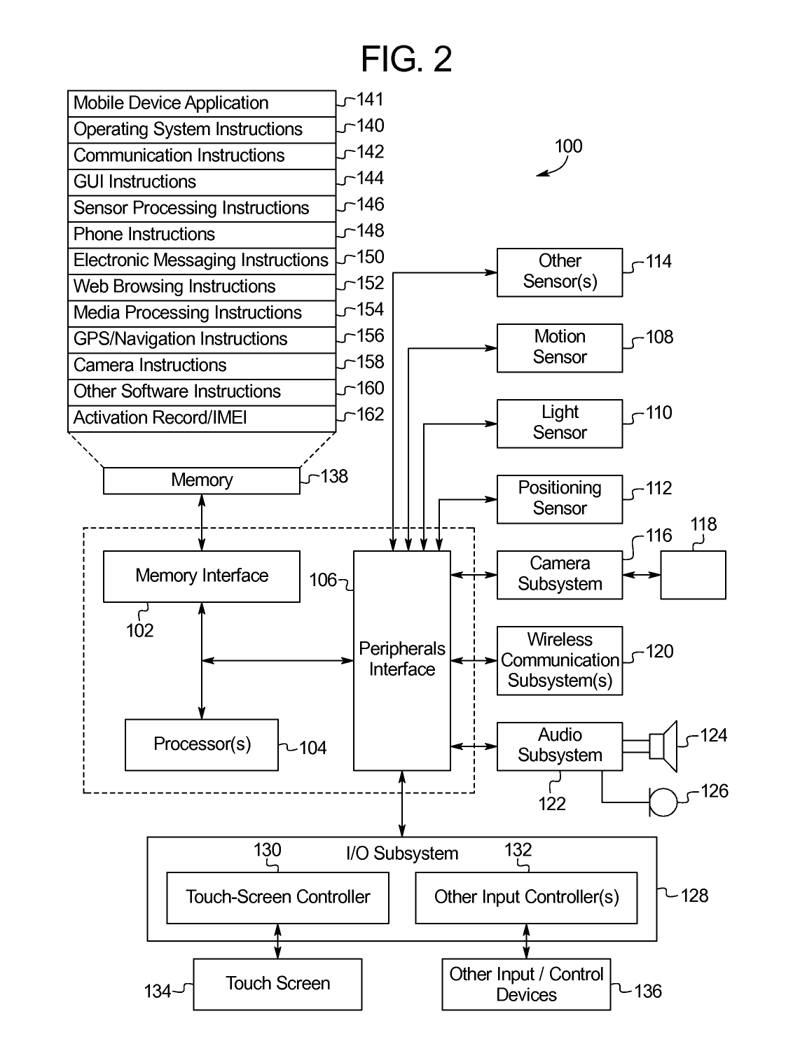

Each user device 100 may be a smartphone, such as an iOS- or Android-enabled smartphone, running a mobile device application 141 (FIG. 2) of the self-identifying messaging system 10. The communication between the user devices 100 may be coordinated by a chat server 40 that may, for example, receive and forward messages 50 from the first user 20 to the second user 30 over a network 60, such as the Internet. The first user 20 and second user 30 may each have a personal font 70 that is generated by each user, exchanged between the first user 20 and the second user 30, and used to display messages 50 from the corresponding user. A personal font 70 may be embodied as a file including a set of scalable vectors describing the rendering of the user-generated glyphs 80. The personal font 70 may additionally include a mapping of user-generated glyphs 80 to characters of an outside encoding, such as Unicode.

FIG. 2 is a block diagram representation of an example implementation of an example user device 100 of the self-identifying messaging system 10. As shown in FIG. 2, in an embodiment, the self-identifying messaging system 10 may include a mobile device application 141 that may be installed on the user devices 100. As noted, the mobile device application 141 may permit the first user 20 to send messages to the second user 30 using the mobile device application 141, and vice versa. Additionally, in some embodiments, the mobile device application 141 may permit the first user 20 to send messages to mobile devices 100 not running the mobile device application 141. For example, the mobile device application 141 may permit the first user 20 to send messages 50 to other mobile devices 100 via SMS, email, or other communication protocols. The user devices 100 may be mobile devices 100 such as an iOS®, Android®, Windows® or other commercially available or special purpose mobile device 100.

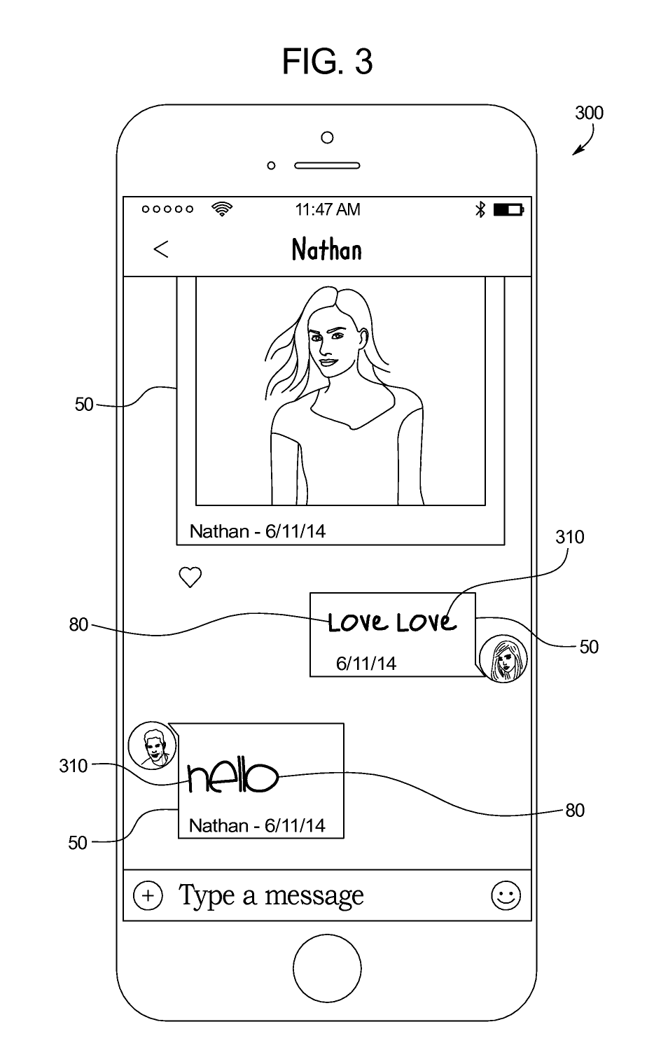

FIG. 3 illustrates a chat window 300 of the mobile device application 141. As shown, the first user 20 and the second user 30 may send messages 50 to each other each using their own personal font 70. Each message 50 may include message text 310 that may be rendered using the user-generated glyphs 80 of each user's personal font 70 and may additionally include media such as images, sound, video, etc.

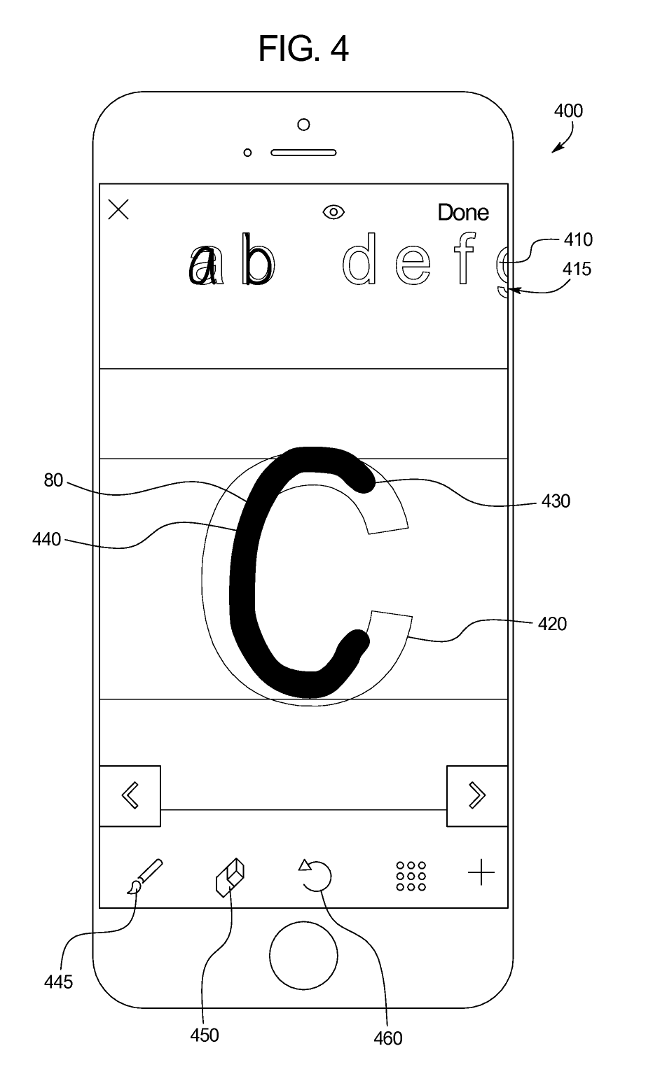

To provide a personal font 70 for use in chat, the first user 20 may generate the personal font 70, by a variety of font generation mechanisms provided by the mobile device application 141 to permit the first user 20 to use a convenient mechanism. For example, as shown in FIG. 4, the first user 20 may access an integrated drawing pad screen 400 of the mobile device application 141 to input user-generated glyphs 80. The first user 20 may choose which characters 410 of a character set 415 to include or exclude for input as user-generated glyphs 80. For example, the first user 20 may be prompted to choose whether to enter lower case (a-z), upper case (A-Z), punctuations, numbers, foreign characters, emoticons, user drawings, etc., as user-generated glyphs 80. The integrated drawing pad screen 400 may then prompt the first user 20 with a character prompt 420. The first user 20 may draw over the character prompt 420 using the user interface 134. In an embodiment, the user interface 134 is a touchscreen. The user device 100 may record the user input 440 from the user interface 134 and simultaneously display the resulting glyph 430 overlaid over the character prompt 420. The user input 440 may be used to create a user-generated glyph 80 for that character prompt 420. The first user 20 may be permitted to re-draw the glyph 430 until perfected.

Each user-generated glyphs 80 may be associated with the corresponding character 410 to permit the mobile device application 141 to define the personal font 70 and to permit the mobile device application 100 to render a viewable message 50 from a digitally readable character encoding of the message 50.

The first user 20 may also be permitted to choose line width, line shape, line color, stippling, and other drawing effects to permit a wide variety of expression. For example, the first user 20 may select a brush button 445 to change the line width, line shape, line color, stippling, etc. An erase button 450 may be displayed to permit the user to erase a portion of the user input 440. An undo button 460 may permit the first user 20 to undo changes, such as undoing additional brush strokes stroke-by-stroke, or undoing changes to the line width, line shape, line color, stippling, etc. The first user 20 may also be permitted to chose a font type for the underlying character prompt 420 to permit the first user 20 to emulate a variety of font styles.

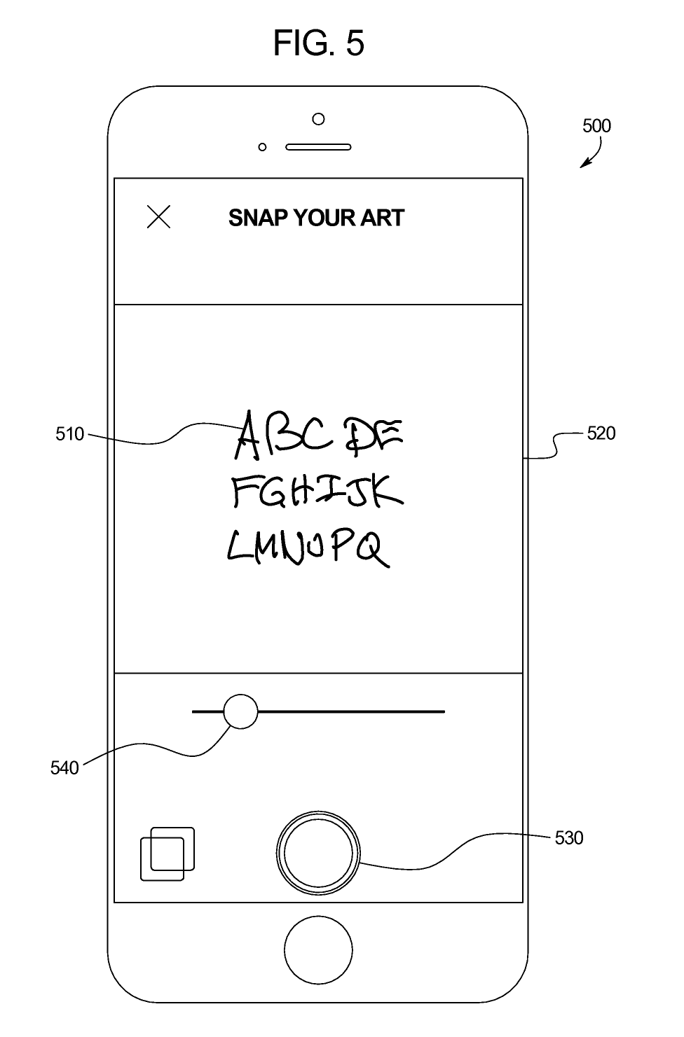

As another example of a font generation mechanisms, the first user 20 may input one or more user-generated glyphs 80 by taking an image 520 of the user-generated glyphs 80 using a font capture screen 500 of FIG. 5. The first user 20 may begin by drawing one or more hand-drawn glyphs 510 on a drawing surface, such as paper. The first user 20 may then open the font capture screen 500 for capture. The font capture screen 500 may display a processed live feed from the camera 118. In an embodiment, the mobile device application 141 may process the live feed by inverting the colors (thus turning black hand-drawn glyphs 510 from black to white) and applying a brightness threshold filter controlled by a brightness threshold slider 540. When the first user 20 has the hand-drawn glyphs 510 appropriately centered and in-focus in the live feed, the first user 20 may press a shutter button 530 to capture an image 520 of the hand-drawn glyphs 510.

The mobile device application 141 may then use optical character recognition (OCR) to recognize the character 410 corresponding to each hand-drawn glyph 510 to generate a user-generated glyph 80. In some embodiments, the mobile device application 141 may present the recognized hand-drawn glyph 510 to the first user 20, and allow the first user 20 to fine-tune the segmentation by manually selecting which part of the image to record as which character 410. The font capture screen 500 may include various tools to fine-tune the recognition of user-generated glyph 80, such as the brightness threshold slider 540 to permit the improved recognition of hand-drawn glyph 510 relative to the background.

For either of the font generation mechanisms, the first user 20 may be permitted to input less than the whole set of characters 410 for a font. Once the first user 20 writes a predetermine number of characters 410 of the character set 415, the self-identifying messaging system 10 may then auto-fill the rest of the characters 410 of the character set 415 with simulated user-generated glyphs 80 to complete the personal font 70 by leveraging a database 45 of other users' personal fonts 70 and identifying the ones that resemble the first user's style.

For example, the provided user-generated glyphs 80 from the first user 20 may be uploaded by the user device 100 to the chat server 40. The chat server 40 may scan the database 45 of stored fonts 47 to match the user-generated glyphs 80 from the first user 20 to user-generated glyphs 80 of the stored fonts 47. In an embodiment, the top matching stored font 47 may be used to fill in user-generated glyphs 80 for those characters 410 for which the first user 20 did not provide user-generated glyphs 80. It is contemplated that the user-generated glyphs 80 does not need to match a stored font 47 exactly to form a match, rather the top scoring match may be determined by a similarity score calculated for the user-generated glyphs 80 and the stored personal fonts 47.

In another embodiment, a plurality of matching stored personal fonts 47 may be combined or interpolated to fill in user-generated glyphs 80. Alternatively, in other embodiments, machine learning and artificial intelligence methods may be used to generate the remaining user-generated glyphs 80 by using the user-generated glyphs 80 as inputs to a generative model. Thus, the first user 20 may provide user-generated glyphs 80 for characters 410 such as ‘A’ through ‘M’, and may request an auto-generation of characters 410 such as ‘N’ through ‘Z’. Although described as being generated by the chat server 400, it is contemplated that auto-generation may be accomplished by the user device 100.

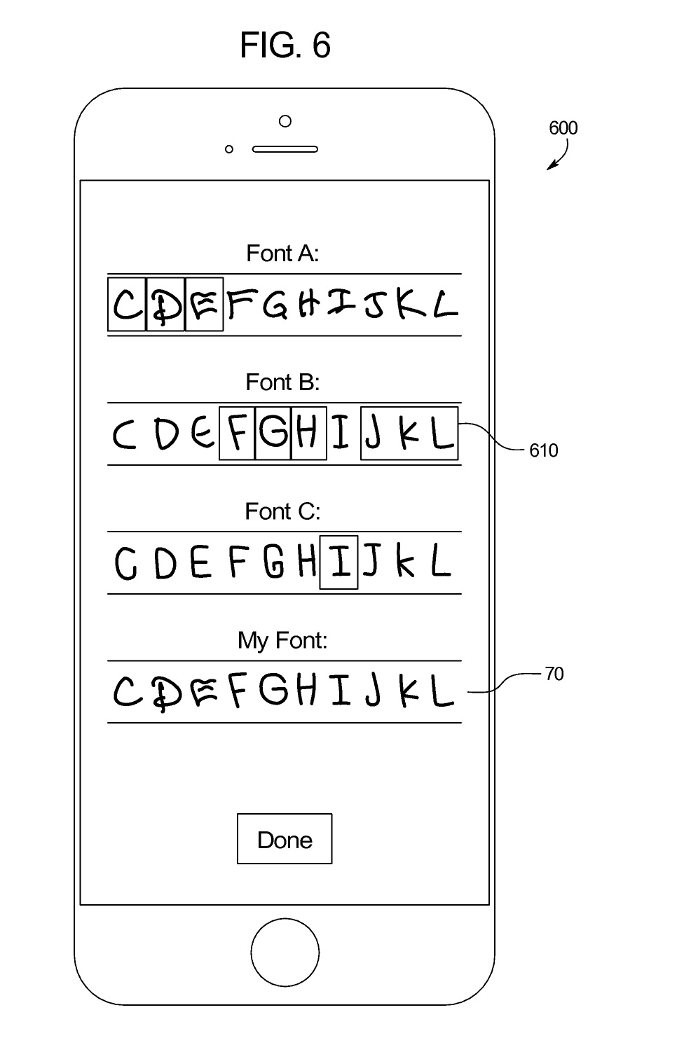

In further embodiments of a font generation mechanisms, the first user 20 may be permitted to “remix” other user's personal fonts 70 using a remix screen 600 of FIG. 6. The first user 20, for example, may choose one or more selected glyphs 610 from one or more stored personal fonts 47 of the database 45 for inclusion in a personal font 70. As shown, the first user 20 has selected the user-generated glyphs 80 ‘C’, ‘D’, and ‘E’ from Font A, the user-generated glyphs 80 ‘E’, ‘F’, ‘G’, ‘H’, ‘J’, ‘K’, and ‘L’ from Font B, and the user-generated glyph 80 T from Font C. Once chosen, the first user 20 may be presented with the integrated drawing pad screen 400 to tweak the designs of individual user-generated glyphs 80.

When the first user 20 has finished editing the user-generated glyphs 80 using any of the font generation mechanisms, the user device 100 generates a personal font 70 by converting the user-generated glyphs 80 into a set of scalable vectors and creating a font definition file in the first user's personalized library both locally and on the chat server 40. The font definition file may be associated with the first user 20 and may be distributed to the second user 30 and other chat partners to permit the correct display of the first user's messages 50. It is contemplated that the first user 20 may be associated with more than one personal font 70.

Once the first user 20 has defined a personal font 70, it may be used when sending messages 50. To send the message 50 between the user devices 100 of the first user 20 and the second user 30, the message text 310 of the message 50 is sent together with metadata 55 identifying the selected personal font 50 to the chat server 40. The chat server 40 may then deliver the message 50 to the user device 100 of the second user 30. The message 50 may include metadata 55 referencing the personal font 70 to use to render the message 50. The referenced personal font 70 may be delivered by a variety of methods as will be described. In an embodiment of the self-identifying messaging system 10, any or all of the described delivery methods may be used.

In the first delivery method, for each message 50, a subset of the user-generated glyphs 80 of the personal font 70 sufficient to render the message 50 along with the message text 310 is sent from the first user 20 to the second user 30. For example, the user-generated glyphs 80 [“I”,“L”,“O”,“V”,“E”,“Y”,“U”] may be sent for the message “I LOVE YOU.” This implementation minimizes the payload size and the number of requests when sending the first and subsequent messages 50.

In a second implementation, all user-generated glyphs 80 for all characters in the personal font 70 are delivered with the first message 51 sent from the first user 20 to the second user 30. This implementation minimizes the payload size over the long run since no user-generated glyphs 80 need to be sent on subsequence messages 50.

In a third implementation, only an ID, name, or uniform resource locator of the personal font 70 is sent. For example, the user device 100 of the first user 20 may send a uniform resource locator (URL) pointing to the personal font 70 on a server such as the chat server 40. The second user device 101 may then download and locally store the required personal font 70 for rendering as needed. This implementation minimizes the payload size of the message 50 but requires an extra request to download the personal font 70 from the chat server 40. For example, in an embodiment, the message 50 is sent via SMS. The SMS metadata or message may include a URL, such as a “shortened” URL (a URL using only a domain and top-level domain constructed to have a short character length) that permits the receiving device to access the personal font 70.

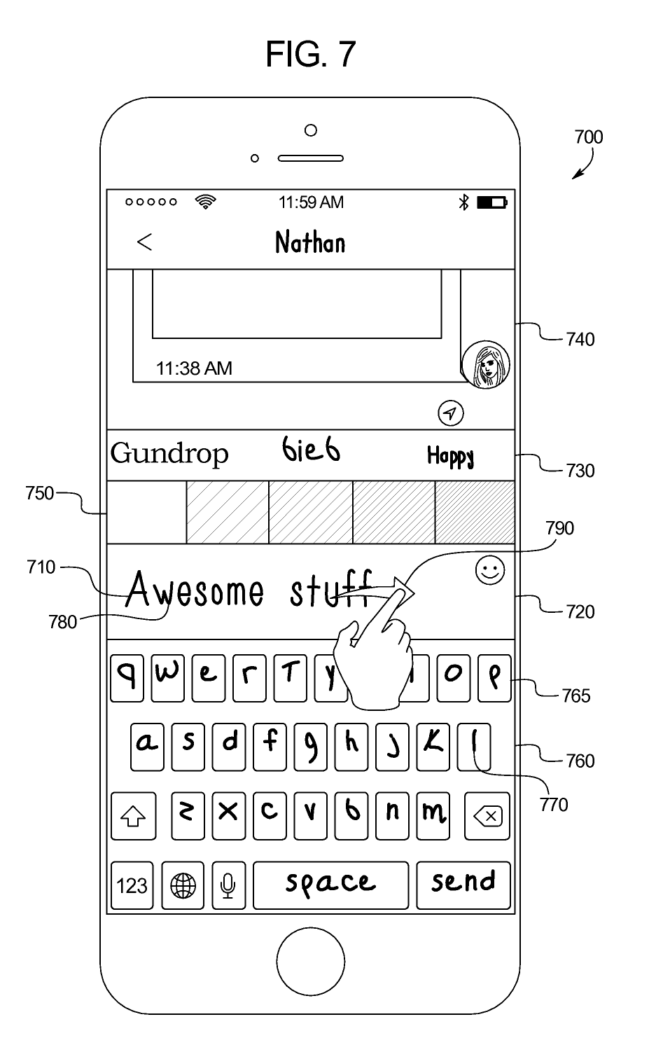

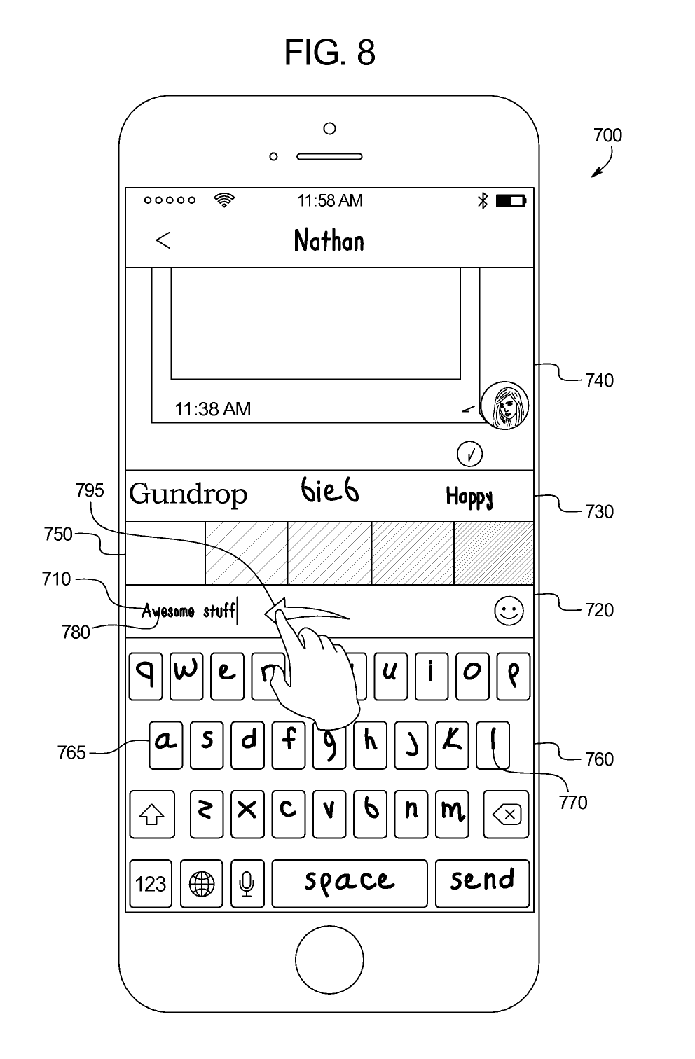

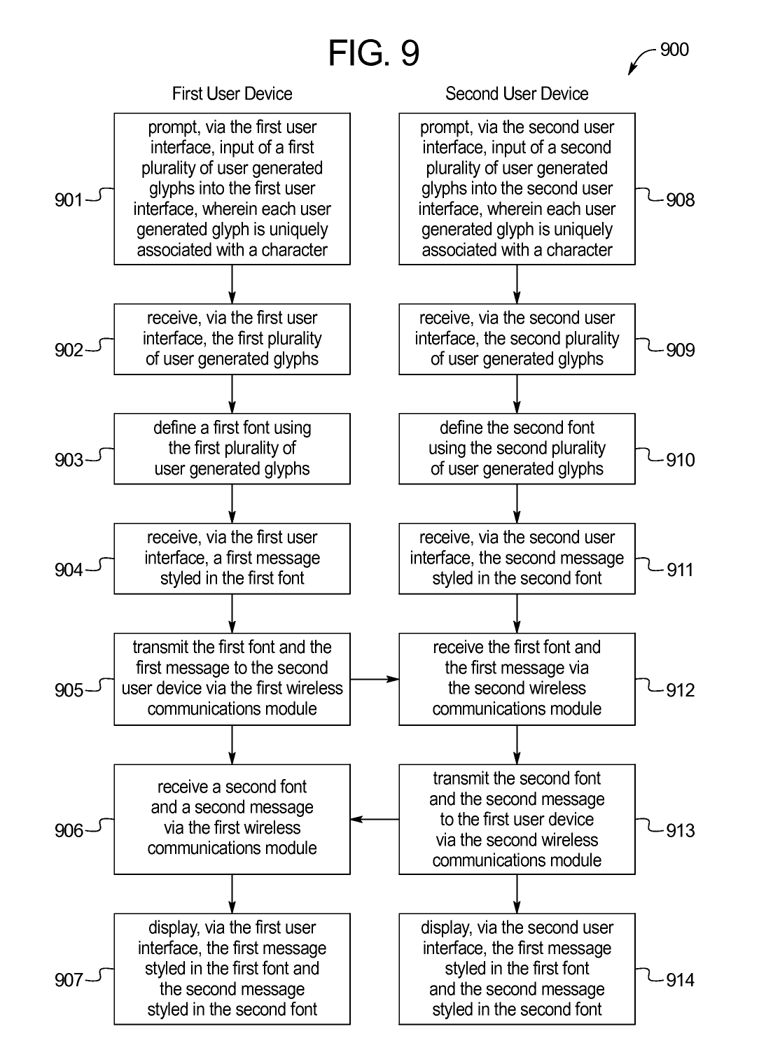

Turning to FIGS. 7 and 8, shown is a messaging screen 700 of a conversation 740 between the first user 20 and the second user 30. The first user 20 may be permitted to choose a personal font 70 from a personalized library menu 730. The first user 20 may then type a message 50 in the chosen personal font 70. A font color menu 750 may also be included in the messaging screen 700 to permit the first user 20 to vary the color of the message 50. To permit increased expressivity, the first user 20 may be permitted to vary a font size for the message 50.

To permit font size adjustment, the self-identifying messaging system 10 may include gesture-based adjustment of font and character sizes. In the embodiment shown in FIGS. 7 and 8, when the first user 20 is entering message text 710 into a textbox 720 of a messaging screen 700, the first user 20 may swipe right across the textbox 720 with a single finger right swipe gesture 790 to enlarge the text size and swipe left with a left swipe gesture 795 across the textbox 720 to shrink the text size. To prevent unwanted size changes, the self-identifying messaging system 10 may distinguish between a single tap to activate the textbox 720 versus a long swipe to change font size. By providing a one-finger swipe directly on the textbox 720, the self-identifying messaging system 10 permits greater speed and precision when adjusting text size.

It is contemplated that in other embodiments, multi-finger gestures may be used to adjust text size in place of a single finger swipe. Additionally, it is contemplated that in some embodiments the functionality of the left swipe gesture 795 and the right swipe gesture 790 may be reversed, that is, a left swipe gesture 795 may increase the text size and a right swipe gesture 790 may decrease the text size. Further, it is contemplated that other swipe directions may be utilized, for example, the first user 20 may swipe up across the textbox 720 with a single finger to enlarge the text size and swipe down across the textbox 720 to shrink the text size.

Additionally, as shown in the FIGS. 7 and 8, the self-identifying messaging system 10 may include a keyboard 760 that displays a chosen personal font 70 on the keys 765. The first user 20 may change the selected personal font 70 by scrolling through a list of available fonts in the personalized library menu 730. When a user chooses a personal font 70 in the list, the keyboard 760 may be updated to show a user-generated glyph 80 for each font character 770 of the personal font 70 in the appropriate location. In some embodiments, the first user 20 may change personal fonts 70 for different message characters 780 of a message 50 to permit greater expressivity in the message 50, such as emphasizing words, showing emotion, changing tone, etc.

Turning to FIG. 9, in an embodiment, the self-identifying messaging system 10 may be embodied in an electronic messaging system including a first user device 101 and a second user device 103. The first user device 101 may be in communication with the second user device 103. Each user device 100 may include a wireless communication subsystem 120 a user interface 134, a controller 104, and a memory 138. Each controller 104 may be in communication with and control the operation of the wireless communication subsystems 120, the user interfaces 134 and the memories 138 of each respective user device 100. The memory 138 may include stored instructions, such as the mobile device application 141. When executed by the controllers 104, the stored instruction may cause the controllers 104 to carry out the messaging method 900 of FIG. 9. As will be understood by those of skill in the art, the various steps of the messaging method 900 may be performed in an order that differs from the numerical order in which the steps are listed.

As shown in FIG. 9, beginning at step 901, the mobile device application 141 causes the first user device 101 to prompt, via the first user interface 134, input of a first plurality of user-generated glyphs 80 into the first user interface 134, wherein each user-generated glyph 80 is uniquely associated with a character 410. Then, at step 902, the first user device 101 receives, via the first user interface, the first plurality of user-generated glyphs 80. At step 903, the first user device 101 defines a first font using the first plurality of user-generated glyphs 80. At step 904, the first user device 101 receives, via the first user interface 134, a first message 51 styled in the first personal font 71. At step 905, the first user device 101 transmits the first font 71 and the first message 51 to the second user device 103 via the first wireless communications module 120. At step 906, the first user device 101 receives a second font 73 and a second message 53 via the first wireless communications module 120 from the second user device 103. Next, at step 907, the first user device 101 displays, via the first user interface, the first message 51 styled in the first font 71 and the second message 53 styled in the second font 73.

Continuing at step 908, the mobile device application 141 causes the second user device 103 to prompt, via the second user interface 134, input of a second plurality of user-generated glyphs 80 into the second user interface 134, wherein each user-generated glyph 80 is uniquely associated with a character 410. Next, at step 909, the second user device 103 receives, via the second user interface 134, the second plurality of user-generated glyphs 80. At step 910, the second user device 103 defines the second font 73 using the second plurality of user-generated glyphs 80. At step 911, the second user device 103 receives, via the second user interface 134, the second message 53 styled in the second font 73. At step 912, the second user device 103 receives the first font 71 and the first message 51 via the second wireless communications module 120. At step 913, the second user device 103 transmits the second font 73 and the second message 53 to the first user device 101 via the second wireless communications module 134. Finally, at step 914, the second user device 103 displays, via the second user interface 134, the first message 51 styled in the first font 71 and the second message 53 styled in the second font 73.

Referring back to FIG. 2, the user device 100 includes a memory interface 102, one or more data controllers, image controllers and/or central controllers 104, and a peripherals interface 106. The memory interface 102, the one or more controllers 104 and/or the peripherals interface 106 can be separate components or can be integrated in one or more integrated circuits. The various components in the user device 100 can be coupled by one or more communication buses or signal lines, as will be recognized by those skilled in the art.

Sensors, devices, and additional subsystems can be coupled to the peripherals interface 106 to facilitate various functionalities. For example, a motion sensor 108 (e.g., a gyroscope), a light sensor 110, and a positioning sensor 112 (e.g., GPS receiver) can be coupled to the peripherals interface 106 to facilitate the orientation, lighting, and positioning functions described further herein. Other sensors 114 can also be connected to the peripherals interface 106, such as a proximity sensor, a temperature sensor, a biometric sensor, or other sensing device, to facilitate related functionalities.

A camera subsystem 116 and an optical sensor 118 (e.g., a charged coupled device (CCD) or a complementary metal-oxide semiconductor (CMOS) optical sensor) can be utilized to facilitate camera functions, such as recording photographs and video clips.

Communication functions can be facilitated through one or more wireless communication subsystems 120, which can include radio frequency receivers and transmitters and/or optical (e.g., infrared) receivers and transmitters. The specific design and implementation of the communication subsystem 120 can depend on the communication network(s) over which the user device 100 is intended to operate. For example, the user device 100 can include communication subsystems 120 designed to operate over a GSM network, a GPRS network, an EDGE network, a Wi-Fi or WiMax network, and a Bluetooth network. In particular, the wireless communication subsystems 120 may include hosting protocols such that the user device 100 may be configured as a base station for other wireless devices.

An audio subsystem 122 can be coupled to a speaker 124 and a microphone 126 to facilitate voice-enabled functions, such as voice recognition, voice replication, digital recording, and telephony functions.

The I/O subsystem 128 can include a touch screen controller 130 and/or other input controller(s) 132. The touch-screen controller 130 can be coupled to a user interface 134, such as a touch screen. The user interface 134 and touch screen controller 130 can, for example, detect contact and movement, or break thereof, using any of a plurality of touch sensitivity technologies, including but not limited to capacitive, resistive, infrared, and surface acoustic wave technologies, as well as other proximity sensor arrays or other elements for determining one or more points of contact with the touch screen 134. The other input controller(s) 132 can be coupled to other input/control devices 136, such as one or more buttons, rocker switches, thumb-wheel, infrared port, USB port, and/or a pointer device such as a stylus. The one or more buttons (not shown) can include an up/down button for volume control of the speaker 124 and/or the microphone 126.

The memory interface 102 can be coupled to memory 138. The memory 138 can include high-speed random access memory and/or non-volatile memory, such as one or more magnetic disk storage devices, one or more optical storage devices, and/or flash memory (e.g., NAND, NOR). The memory 138 can store operating system instructions 140, such as Darwin, RTXC, LINUX, UNIX, OS X, iOS, ANDROID, BLACKBERRY OS, BLACKBERRY 10, WINDOWS, or an embedded operating system such as VxWorks. The operating system instructions 140 may include instructions for handling basic system services and for performing hardware dependent tasks. In some implementations, the operating system instructions 140 can be a kernel (e.g., UNIX kernel).

The memory 138 may also store communication instructions 142 to facilitate communicating with one or more additional devices, one or more computers and/or one or more servers. The memory 138 may include graphical user interface instructions 144 to facilitate graphic user interface processing; sensor processing instructions 146 to facilitate sensor-related processing and functions; phone instructions 148 to facilitate phone-related processes and functions; electronic messaging instructions 150 to facilitate electronic-messaging related processes and functions; web browsing instructions 152 to facilitate web browsing-related processes and functions; media processing instructions 154 to facilitate media processing-related processes and functions; GPS/Navigation instructions 156 to facilitate GPS and navigation-related processes and instructions; camera instructions 158 to facilitate camera-related processes and functions; and/or other software instructions 160 to facilitate other processes and functions (e.g., access control management functions, etc.). The memory 138 may also store other software instructions controlling other processes and functions of the user device 100 as will be recognized by those skilled in the art. In some implementations, the media processing instructions 154 are divided into audio processing instructions and video processing instructions to facilitate audio processing-related processes and functions and video processing-related processes and functions, respectively. An activation record and International Mobile Equipment Identity (IMEI) 162 or similar hardware identifier can also be stored in memory 138.

Each of the above identified instructions and applications can correspond to a set of instructions for performing one or more functions described herein. These instructions need not be implemented as separate software programs, procedures, or modules. The memory 138 can include additional instructions or fewer instructions. Furthermore, various functions of the user device 100 may be implemented in hardware and/or in software, including in one or more signal processing and/or application specific integrated circuits. Accordingly, the user device 100, as shown in FIG. 2, may be adapted to perform any combination of the functionality described herein.

One or more controllers 104 control aspects of the systems and methods described herein. The one or more controllers 104 may be adapted run a variety of application programs, access and store data, including accessing and storing data in associated databases, and enable one or more interactions via the user device 100. Typically, the one or more controllers 104 are implemented by one or more programmable data processing devices. The hardware elements, operating systems, and programming languages of such devices are conventional in nature, and it is presumed that those skilled in the art are adequately familiar therewith.

For example, the one or more controllers 104 may be a PC based implementation of a central control processing system utilizing a central processing unit (CPU), memories and an interconnect bus. The CPU may contain a single microprocessor, or it may contain a plurality of microprocessors 104 for configuring the CPU as a multi-processor system. The memories include a main memory, such as a dynamic random access memory (DRAM) and cache, as well as a read only memory, such as a PROM, EPROM, FLASH-EPROM, or the like. The system may also include any form of volatile or non-volatile memory. In operation, the main memory stores at least portions of instructions for execution by the CPU and data for processing in accord with the executed instructions.

The one or more controllers 104 may also include one or more input/output interfaces for communications with one or more processing systems. Although not shown, one or more such interfaces may enable communications via a network, e.g., to enable sending and receiving instructions electronically. The communication links may be wired or wireless.

The one or more controllers 104 may further include appropriate input/output ports for interconnection with one or more output displays (e.g., monitors, printers, user interface 134, motion-sensing input device 108, etc.) and one or more input mechanisms (e.g., keyboard, mouse, voice, touch, bioelectric devices, magnetic reader, RFID reader, barcode reader, user interface 134, motion-sensing input device 108, etc.) serving as one or more user interfaces for the controller. For example, the one or more controllers 104 may include a graphics subsystem to drive the output display. The links of the peripherals to the system may be wired connections or use wireless communications.

Although summarized above as a PC-type implementation, those skilled in the art will recognize that the one or more controllers 104 also encompasses systems such as host computers, servers, workstations, network terminals, and the like. Further one or more controllers 104 may be embodied in a user device 100, such as a mobile electronic device, like a smartphone or tablet computer. In fact, the use of the term controller is intended to represent a broad category of components that are well known in the art.

Hence aspects of the systems and methods provided herein encompass hardware and software for controlling the relevant functions. Software may take the form of code or executable instructions for causing a controller or other programmable equipment to perform the relevant steps, where the code or instructions are carried by or otherwise embodied in a medium readable by the controller or other machine. Instructions or code for implementing such operations may be in the form of computer instruction in any form (e.g., source code, object code, interpreted code, etc.) stored in or carried by any tangible readable medium.

As used herein, terms such as computer or machine “readable medium” refer to any medium that participates in providing instructions to a controller for execution. Such a medium may take many forms. Non-volatile storage media include, for example, optical or magnetic disks, such as any of the storage devices in any computer(s) shown in the drawings. Volatile storage media include dynamic memory, such as main memory of such a computer platform. Common forms of computer-readable media therefore include for example: a floppy disk, a flexible disk, hard disk, magnetic tape, any other magnetic medium, a CD-ROM, DVD, any other optical medium, punch cards paper tape, any other physical medium with patterns of holes, a RAM, a PROM and EPROM, a FLASH-EPROM, any other memory chip or cartridge, or any other medium from which a computer can read programming code and/or data. Many of these forms of computer readable media may be involved in carrying one or more sequences of one or more instructions to a processor for execution.

It should be noted that various changes and modifications to the presently preferred embodiments described herein will be apparent to those skilled in the art. Such changes and modifications may be made without departing from the spirit and scope of the present invention and without diminishing its attendant advantages.

1. An electronic messaging system comprising:
a first user device; and
a second user device in communication with the first user device;
wherein the first user device includes:
a first wireless communication subsystem,
a first user interface,
a first controller in communication with and controlling the operation of the first wireless communication subsystem and the first user interface, and
a first memory in communication with the first controller, the first memory including instructions that, when executed by the first controller, cause the first controller to:
prompt, via the first user interface, input of a first plurality of user-generated glyphs into the first user interface, wherein each user-generated glyph is uniquely associated with a character,
receive, via the first user interface, the first plurality of user-generated glyphs,
define a first font using the first plurality of user-generated glyphs,
receive, via the first user interface, a first message styled in the first font,
transmit the first font and the first message to the second user device via the first wireless communications module,
receive a second font and a second message via the first wireless communications module, and
display, via the first user interface, the first message styled in the first font and the second message styled in the second font,
wherein the second user device includes:
a second wireless communication subsystem,
a second user interface,
a second controller in communication with and controlling the operation of the second wireless communication subsystem and the second user interface, and
a second memory in communication with the second controller, the second memory including instructions that, when executed by the second controller, cause the second controller to:
prompt, via the second user interface, input of a second plurality of user-generated glyphs into the second user interface, wherein each user-generated glyph is uniquely associated with a character,
receive, via the second user interface, the second plurality of user-generated glyphs,
define the second font using the second plurality of user-generated glyphs,
receive, via the second user interface, the second message styled in the second font,
transmit the second font and the second message to the first user device via the second wireless communications module,
receive the first font and the first message via the second wireless communications module, and
display, via the second user interface, the first message styled in the first font and the second message styled in the second font.

2. The electronic messaging system of claim 1, wherein the first user interface includes a touchscreen interface, wherein the step of prompting input of the first plurality of user-generated glyphs includes displaying a character on the touchscreen interface, wherein the step of receiving, via the first user interface, the first plurality of user-generated glyphs includes receiving a series of points via the touchscreen interface.

3. The electronic messaging system of claim 1, wherein the step of defining the first font using the first plurality of user-generated glyphs includes generating a scalable vector representation of each of the first plurality of user-generated glyphs.

4. The electronic messaging system of claim 1, wherein the first plurality of user-generated glyphs is a set of a series of points received by the first user interface, wherein each user-generated glyph is defined by a series of points of the set.

5. The electronic messaging system of claim 1, wherein the first plurality of user-generated glyphs includes a first selection of glyphs from a first font and a second selection of glyphs from a second personal font, wherein the step of defining the font from the first user-generated glyphs includes defining the first font to include the first selection of glyphs and the second selection of glyphs.

6. The electronic messaging system of claim 1, wherein the first plurality of user-generated glyphs is received via a camera input.

7. The electronic messaging system of claim 6, wherein the step of defining the first font from the user-generated glyphs includes performing optical character recognition on a portion of the camera input to segment the camera input into the first plurality of user-generated glyphs.

8. The electronic messaging system of claim 1, further including a chat server including a database of stored personal fonts, wherein the chat server is configured to:
receive the first plurality of user-generated glyphs,
select a font from the stored personal fonts, wherein the selected font includes glyphs matching the first plurality of user-generated glyphs, and
select glyphs from the selected font for a plurality of characters not associated with the first plurality of user-generated glyphs to include in the first font.

9. The electronic messaging system of claim 1, wherein the memory includes further instructions that, when executed by the controller, cause the controller to:
display a textbox including text of a user-entered message, wherein the text includes a font size,
when the first user interface receives a swipe right gesture over the textbox, increase the font size of the text of the user-entered message, and
when the first user interface receives a swipe left gesture over the textbox, decrease the font size of the text of the user-entered message.

10. The electronic messaging system of claim 1, wherein the memory includes further instructions that, when executed by the controller, cause the controller to:
display a messaging screen including a keyboard, wherein the keyboard includes a plurality of keys, each key including a user-generated glyph.
